(19) United States
(12) Patent Application Publication
(10) Pub. No.: US 2013/0042297 A1
(43) Pub. Date: Feb. 14, 2013

(54) METHOD AND APPARATUS FOR PROVIDING SECURE SOFTWARE EXECUTION ENVIRONMENT BASED ON DOMAIN SEPARATION

(71) Applicants: YoungHo KIM, Daejeon (KR); Jeon Nyeo KIM, Daejeon (KR); Yong-Sung JEON, Daejeon (KR); Hong Il JU, Daejeon (KR); Yun-Kyung LEE, Daejeon (KR)

(72) Inventors: YoungHo KIM, Daejeon (KR); Jeon Nyeo KIM, Daejeon (KR); Yong-Sung JEON, Daejeon (KR); Hong Il JU, Daejeon (KR); Yun-Kyung LEE, Daejeon (KR)

(73) Assignee: Electronics and Telecommunications Research Institute, Daejeon (KR)

(21) Appl. No.: 13/476,998

(22) Filed: May 21, 2012

(30) Foreign Application Priority Data
Aug. 12, 2011 (KR) 10-2011-0080381

(51) Int. Cl. G06F 21/00

(52) U.S. Cl. 726/1

(57) ABSTRACT

An apparatus for providing a secure environment of software execution in a terminal device includes a normal service domain and a secure service domain into which a domain of the software is divided based on virtualization. The normal service domain executes a normal service on elements of the software, and the secure service domain executes a security service on elements of the software in response to a request for a security service of the software elements from the normal service domain.

### RELATED APPLICATION(S)

This application claims the benefit of Korean Patent Application No. 10-2011-0080381, filed on Aug. 12, 2011, which is hereby incorporated by reference as if fully set forth herein.

### FIELD OF THE INVENTION

The present invention relates to a method and apparatus for stably executing software in a terminal device, and more particularly, to a method and apparatus for providing a secure environment of software execution in a terminal device based on domain separation.

### BACKGROUND OF THE INVENTION

In general, software and data in a terminal device are protected against an external attack through a dedicated hardware or program to detect a malicious code in the terminal device. In particular, in case of a method of protecting software and data in the terminal device using the dedicated hardware, an encryption algorithm and key information are contained and managed within a separate closed physical component in the terminal device. This method has high stability but it is applied only in very limited use due to a resource constraint of the physical component. Thus, there is a limitation of protecting various complicated programs or execution environments operated in the terminal device.

Meanwhile, a method using the dedicated program does not have a limitation in physical resource in comparison to the method using the dedicated hardware. However, since a platform for executing software in the terminal device includes a single software domain, critical information in the terminal device may be leaked illegally by hacking and unlawful rooting attack. That is, in a software execution environment of the terminal device, an operating system and an application program constitute a single software domain, and thus execution information of every software executed in the single software domain and critical data may be illegally leaked due to an external malicious attack or an internal software defect. Currently, as for a security technique in a terminal device environment, a malicious code detection and access control technique or the like is approached in a software manner of an application program or operating system level. Therefore, such techniques are vulnerable to an attack such as hacking or rooting. Thus, in order to provide security and safety with respect to a program execution essentially required in a mobile office or a financial service, a terminal security solution is urgently required.

### SUMMARY OF THE INVENTION

In view of the above, the present invention provides a method and apparatus for providing secure environment of software execution in a terminal device based on domain separation.

In accordance with an aspect of the present invention, there is provided an apparatus for providing secure execution environment of software executed in a terminal device. The apparatus includes a normal service domain and a secure service domain into which a domain of the software is divided based on virtualization, wherein the normal service domain executes a normal service on elements of the software, and the secure service domain executes a security service on elements of the software in response to a request for a security service of the software elements from the normal service domain.

The normal service domain may include:

a normal service application configured to make the request for a security service of the software elements;

a secure service application programming interface (API) configured to transfer the security service request to the secure service domain; and

a front end driver configured to link with the secure service domain so that the security service request is transmitted to the secure service domain.

The secure service domain may include:

a secure service application configured to execute a separate independent execution on the software elements;

an encryption module configured to perform an encryption execution on the software elements; and

an encryption API configured to provide an interface through which the secure service application accesses the encryption module to call the encryption execution.

The secure service domain may further include:

a back end driver configured to determine whether or not the security service request made by the normal service domain is a service requiring the separate independent execution or the encryption execution, transfer the security service request to the encryption module or the secure service application based on the determination result, and returning an execution result from the encryption module or the secure service application to the normal service domain.

The security service request may be transmitted from the normal service domain to the secure service domain by using a communication method between the normal service domain and the secure service domain.

In accordance with another aspect of the present invention, there is provided a method for providing secure execution environment of software executed in a terminal device. The method includes:

dividing a domain of the software into a normal service domain and a secure service domain;

when the normal service domain makes a request for a security service of elements of the software, transmitting the security service request to the secure service domain; and

executing, in response to the security service request, the security service on the software elements in the secure service domain; and

transmitting a execution result obtained by the secure service domain to the normal service domain.

In the method, the transmitting the security service request to the secure service domain may includes:

requesting the security service required for the software elements from a normal service application of the normal service domain;

calling a secure service application programming interface (API) of the normal service domain;

linking with the secure service domain through a front end driver of the normal service domain to transmit the security service request from the secure service API to a back end driver of the safety service domain; and

performing the security service on the software elements in a secure service application of the secure service domain.

In the method, the transmitting the security service request to the secure service domain may include:

requesting the security service required for the software elements from a normal service application;

calling a secure service application programming interface (API) of the normal service domain;

linking with the secure service domain through a front end driver of the normal service domain to transmit the security service request from the secure service API to a back end driver of the safety service domain; and

performing the security service on the software elements in an encryption module of the secure service domain.

The method may further include:

requesting the security service from a safety service application of the safety service domain;

calling an encryption module of the safety service domain; and

performing the security service on the software elements in the encryption module.

### BRIEF DESCRIPTION OF THE DRAWINGS

The above and other objects and features of the present invention will become apparent from the following description of embodiments, given in conjunction with the accompanying drawings, in which:

FIG. 1 is a block diagram of an apparatus for providing a secure environment of software execution in a terminal device based on domain separation in accordance with an embodiment of the present invention;

FIG. 2 illustrates an exemplary call path of a security service request made from a normal service domain to a safety service domain in accordance with an embodiment of the present invention; and

FIG. 3 is a sequential diagram illustrating a method for processing a security service between a normal service domain and a secure service domain in accordance with an embodiment of the present invention.

### DETAILED DESCRIPTION OF THE EMBODIMENTS

Embodiments will be described in detail with reference to the accompanying drawings so that they can be readily implemented by those skilled in the art.

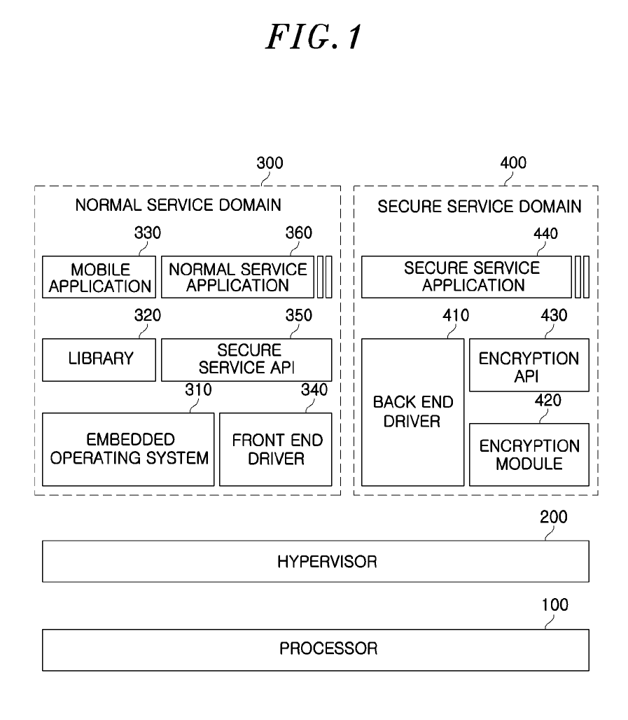

FIG. 1 is a block diagram of an apparatus for providing a secure environment of software execution in a terminal device based on domain separation in accordance with an embodiment of the present invention.

Referring to FIG. 1, the apparatus includes two software domains, namely, a normal service domain 300 and a secure service domain 400, based on a virtual machine monitor or hypervisor 200 executed on a processor 100 which is a physical device. In the embodiment, the apparatus may be implemented in a form of software or hardware in a terminal device. The terminal device may include, but not limited to, a personal computer (PC), a personal digital assistant (PDA), and a smart phone, or the like. Further, a domain separation is not limited to a particular technique and may include any methods for generating mutually independent domains by software and/or hardware.

The normal service domain 300 has generally an open execution environment which allows a user of the terminal device to install and change new drivers and application programs. The normal service domain 300 has a configuration that a library 320 and a mobile application 330 are executed as upper entities based on an embedded operating system 310 which is the lowest layer. As described above, since the normal service domain 300 has the open execution environment, all software elements executed in the normal service domain 300 may be latently exposed to external security intimidation. The normal service domain 300 further includes a front end driver 340, a secure service application programming interface (API) 350, and a normal service application 360 in order for the software elements to be stably executed against the external security intimidation. These components are used for cooperatively operating with the secure service domain 400 to provide a security service, so that the software elements are served the security service which is not provided in the mobile application 330. In particular, the front end driver 340 links with the secure service domain 400 to transmit a request for the security service to the secure service domain 400.

Unlike the normal service domain 300, the secure service domain 400 has a closed execution environment which does not allow a user to wrongfully access and change components within the secure service domain 400. The secure service domain 400 includes a back end driver 410, an encryption module 420, an encryption API 430, and a secure service application 440.

The encryption module 420 and the encryption API 430 provide an encryption functionality and a programming interface required for executing the secure service application 440, respectively. The back end driver 410 is operable to call an entity within the secure service domain 400 to provide a security service which is requested from the normal service domain 300.

The secure service application 440 is a unit for performing the security service, and has independent execution contexts. In particular, the secure service application 440 is used to implement the safety service, like an agent program of a service provider, apart from general programs that can be installed by the user in the terminal device. Thus, whether to execute the secure service application 440 and internal information required for the execution thereof cannot be directly accessed from the normal service domain 300.

The encryption module 420 may be a module including, for example, an encryption key generation functionality, a random number generation functionality, an encryption and signature algorithm and the like. The encryption module 420 performs a cryptic arithmetic operation. Thus, while the encryption module 420 performs a particular cryptic arithmetic operation, the normal service domain 300 is unaware of internal critical information used in the cryptic arithmetic operation since the cryptic arithmetic operation is executed within the secure service domain 400.

The encryption API 430 allows the secure service application 440 to have transparency of the use of the encryption module 420. It enables the secure service domain 400 to implement the secure service application 440 through the use of the encryption API 430 irrespective of whether or not the encryption module 420 is implemented by using a dedicated software or hardware module.

When the front end driver 340 in the normal service domain 300 requests the security service to the safety service application 440 or the encryption module 420 within the secure service domain 400, the security service request is transferred through the back end driver 410. The back end driver 410 determines whether or not the security service request made by the normal service domain 300 can be served by the security service domain 400, and selectively transfers the security service request to the encryption module 420 or the secure service application 440.

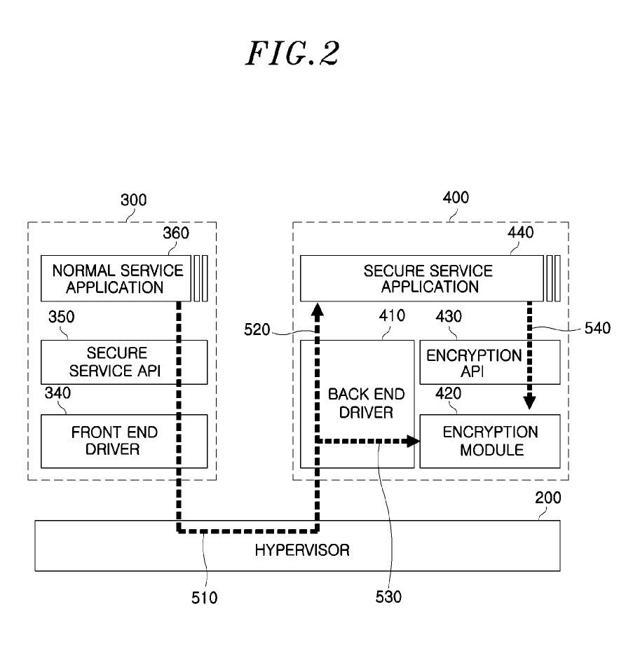

FIG. 2 illustrates an exemplary call path of a security service request made from a normal service domain to a safety service domain in accordance with an embodiment of the present invention.

In this embodiment, scenarios providing a security service to software elements executed in a terminal device may be largely classified into two ones.

In a first scenario, the secure service domain 400 performs a security service alone through the use of the secure service application 440 without interaction with the normal service domain 300. In this case, the secure service application 440 accesses the encryption module 420 via the encryption API 430 to call the encryption functionality from the encryption module 420 or performs a security service in accordance with an execution process of itself.

The secure service application 440 has very low security vulnerability of exposure to outside owing to the closed execution environment of the secure service domain 400 and therefore, internal information related to the security service is not leaked even while the secure service application 440 is being executed. When the secure service application 440 accesses the encryption module 420, the secure service application 440 calls the encryption module 420 to execute the encryption functionality via the encryption API 430 along a call path 540 as illustrated in FIG. 2.

In a second scenario, the normal service application 360 requests the secure service domain 400 for a security service of software elements so that the software element requiring the security service is subjected to be executed within the secure service domain 400, and receives an execution result of the security service from the secure service domain 400.

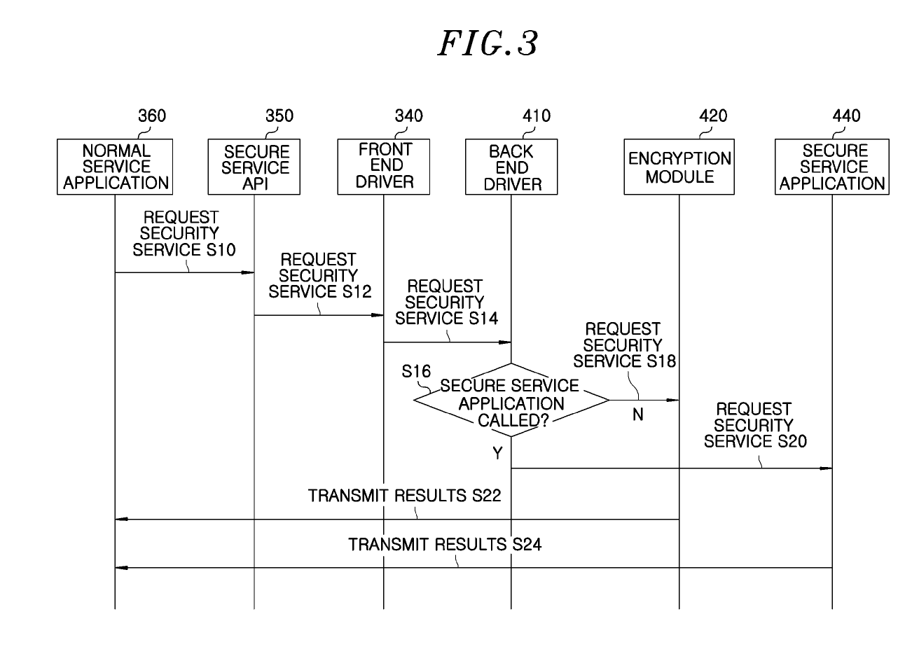

FIG. 3 is a sequential diagram illustrating a method for processing a security service between the normal service domain 300 and the secure service domain 400 in accordance with an embodiment of the present invention. In particular, FIG. 3 is a sequential diagram illustrating the second scenario as described above.

The second scenario for providing a security service in accordance with an embodiment of the present invention will be described in detail with reference to FIGS. 2 and 3.

As set forth earlier, the mobile application 330 performs every software execution in the normal service domain 300. Thus, during the execution of the mobile application 330, an important arithmetic calculation and critical information may be wrongfully leaked due to security infringement which may be occurred in the normal service domain 300. However, in accordance with the embodiment of the present invention, a risk due to security vulnerability can be limited to the normal service domain 300 by virtue of the domain separation.

Following is a description that the secure service domain 400 cooperatively operates with the normal service application 360 to provide a security service.

In order for the normal service application 360 to request the secure service domain 400 for the security service of software elements required to be safely executed, the normal service application 360 needs to call either the encryption module 420 or the secure service application 440 in the secure service domain 400.

First, in step S10, the normal service application 360 requests the security service through the secure service API 350.

The security service request is transferred to the front end driver 340 in the normal service domain 300 in step S12. Such security service request follows a call path 510 as illustrated in FIG. 2. In step S14, the security service request is then transmitted to the back end driver 410 in the secure service domain 400 through the hypervisor 200. The transmission of the security service request may be achieved by a communication method between the normal service domain 300 and the secure service domain 400 provided by the hypervisor 200.

The back end driver 410 then decodes and demultiplexes a message in the security service request in step S16. The decoding and demultiplexing of the message are performed as follows.

First, the back end driver 410 determines whether or not the security service request made by the normal service domain 300 requires a separate independent execution. The security service requiring a separate independent execution refers to a service requiring interaction with the security service application 440 and the security service not requiring a separate independent execution refers to a service requiring an encryption functionality using the encryption module 420 irrespective of the security service application 440.

When the back end driver 410 determines that the security service request is a request which requires the encryption execution, the back end driver 410 transmits the security service request to the encryption module 410 along a call path 530, so that the software elements required for stable execution are encrypted in step S18.

Meanwhile, when the security service request is a request requiring the separate independent execution, the back end driver 410 transmits the security service request to the secure service application 440 along a call path 520 in step S20. Accordingly, the secure service application 440 accesses the encryption module 420 via the encryption API 430 to call the encryption functionality from the encryption module 420 or performs a security service in accordance with an execution process of itself. In this manner, in the processing of the security service request, the encryption module 420 or the secure service application 440 is called through a different path and the relevant security service is performed in the called encryption module or secure service application.

When the security service performed in the encryption module or the secure service application is completed, the encryption module 420 or the secure service application 440 returns an execution result of the security service to the normal service application 360, in reverse order of the call path 530 or 520 in steps S22 and S24.

The results may be accompanied by an error checking code allowing for checking an error fact and its cause in preparation for the occurrence of an error situation. Accordingly, the normal service application 360 can recognize from the error checking code what error fact has been occurred.

In accordance with the embodiment, two independent execution environments are configured by a domain separation based on virtualization, and a security service is provided through a security service channel between the separated domains, thereby enhancing security with respect to software executed in the terminal device and protecting internal critical information against an external unauthorized access.

Further, spreading of invasion resulting from a software attack can be blocked and a stable service can be protected against a wrongful attack through the domain separation.

In addition, a security problem of the execution environment including only a single domain can be solved so that a leakage of enterprise information and user information in a terminal device environment can be prevented and software vulnerability of limiting service such as payment, settlement or the like can be complemented.

While the present invention has been shown and described with respect to the particular embodiments, the present invention is not limited to the embodiments described herein. It will be understood by those skilled in the art that various changes, equivalents, and modifications may be made without departing from the scope of the invention as defined in the following claims.

What is claimed is:

1. An apparatus for providing a secure environment of software execution in a terminal device, comprising:
a normal service domain and a secure service domain into which a domain of the software is divided based on virtualization,
wherein the normal service domain executes a normal service on elements of the software, and the secure service domain executes a security service on elements of the software in response to a request for a security service of the software elements from the normal service domain.

2. The apparatus of claim 1, wherein the normal service domain includes:
a normal service application configured to make the request for a security service of the software elements;
a secure service application programming interface (API) configured to transfer the security service request to the secure service domain; and
a front end driver configured to link with the secure service domain so that the security service request is transmitted to the secure service domain.

3. The apparatus of claim 1, wherein the secure service domain comprises:
a secure service application configured to execute a separate independent execution on the software elements;
an encryption module configured to perform an encryption execution on the software elements; and
an encryption API configured to provide an interface through which the secure service application accesses the encryption module to call the encryption execution.

4. The apparatus of claim 3, wherein the secure service domain further includes:
a back end driver configured to determine whether or not the security service request made by the normal service domain is a service requiring the separate independent execution or the encryption execution, transfer the security service request to the encryption module or the secure service application based on the determination result, and returning an execution result from the encryption module or the secure service application to the normal service domain.

5. The apparatus of claim 1, wherein the security service request is transmitted from the normal service domain to the secure service domain by using a communication method between the normal service domain and the secure service domain.

6. A method for providing a secure environment of software execution in a terminal device, the method comprising:
dividing a domain of the software into a normal service domain and a secure service domain;
when the normal service domain makes a request for a security service of elements of the software, transmitting the security service request to the secure service domain; and
executing, in response to the security service request, the security service on the software elements in the secure service domain; and
transmitting an execution result obtained by the secure service domain to the normal service domain.

7. The method of claim 6, wherein said transmitting the security service request to the secure service domain comprises:
requesting the security service required for the software elements from a normal service application of the normal service domain;
calling a secure service application programming interface (API) of the normal service domain;
linking with the secure service domain through a front end driver of the normal service domain to transmit the security service request from the secure service API to a back end driver of the safety service domain; and
performing the security service on the software elements in a secure service application of the secure service domain.

8. The method of claim 6, wherein said transmitting the security service request to the secure service domain comprises:
requesting the security service required for the software elements from a normal service application of the normal service domain;
calling a secure service application programming interface (API) of the normal service domain;
linking with the secure service domain through a front end driver of the normal service domain to transmit the security service request from the secure service API to a back end driver of the safety service domain; and
performing the security service on the software elements in an encryption module of the secure service domain.

9. The method of claim 7, wherein the security service request is transmitted from the normal service domain to the secure service domain by using a communication method between the normal service domain and the secure service domain.

10. The method of claim 8, wherein the security service request is transmitted from the normal service domain to the secure service domain by using a communication method between the normal service domain and the secure service domain.

11. The method of claim 6, further comprising:
requesting the security service from a safety service application of the safety service domain;
calling an encryption module of the safety service domain; and
performing the security service on the software elements in the encryption module.
